(19) United States
(12) Patent Application Publication
(10) Pub. No.: US 2015/0211290 A1
(43) Pub. Date: Jul. 30, 2015

(54) DOOR ASSEMBLY WITH FLUSH-MOUNTED GLAZING

(71) Applicants: Scott CORLEY, Zeeland, MI (US); Dale A. GORT, Holland (US)

(72) Inventors: Scott E. Corley, Zeeland, MI (US); Dale A. Gort, Holland, MI (US)

(21) Appl. No.: 14/426,610

(22) PCT Filed: Oct. 14, 2013
(86) PCT No.: PCT/US13/64818

§ 371 Date: Mar. 6, 2015

Related U.S. Application Data
(60) Provisional application No. 61/714,466, filed on Oct. 16, 2012.

(51) Int. Cl. E06B 7/30; E06B 3/66; E06B 7/16; E06B 3/70

(52) U.S. Cl. CPC E06B 7/30; E06B 3/70; E06B 3/6612; E06B 3/7015; E06B 7/16; E06B 2003/7023

(57) ABSTRACT

A door assembly may include a door defining a first face, a second face opposite the first face, and an opening formed there through from the first face to the second face, a glazing mounted to at least the first face of the door about the opening, and a recess defined in the first face of the door about the opening. The glazing may include a first panel unit defining a first exterior surface and a first interior surface opposite the first exterior surface, and a second panel unit spaced apart from and facing the first interior surface of the first panel unit. The recess may be sized to receive therein the first interior surface of the first panel unit of the glazing with a plane defined by the first exterior surface of the first panel unit substantially flush with a plane defined by the first face of the door.

### CROSS-REFERENCE TO RELATED APPLICATIONS

This patent application claims the benefit of, and priority to, Provisional Patent Application Ser. No. 61/714,466, filed Oct. 16, 2012, the disclosure of which is incorporated herein by reference.

### BACKGROUND

Conventional interior and exterior doors may include one or more glazings or glazing units to allow passage of light and/or to provide aesthetic appeal. Doors with such added glazing typically are formed to include an opening to receive the glazing or such an opening is formed after fabrication of the door. In order to retain the glazing within the opening, a pair of frame members are typically mounted to each of the opposing faces of the door, wherein such frame members at least partially overlap the glazing.

### SUMMARY

The present invention may comprise one or more of the features recited in the attached claims, and/or one or more of the following example features and combinations thereof. In one aspect, a door assembly may comprise a door defining a first face, a second face opposite the first face, and an opening formed therethrough between the first and second faces, a glazing mounted to at least the first face of the door about the opening and a recess defined in the first face of the door about the opening. The glazing may illustratively include a first panel unit defining a first exterior surface and a first interior surface opposite the first exterior surface, and a second panel unit defining a second exterior surface and a second interior surface opposite the second exterior surface, and the first interior surface of the first panel unit may be spaced apart from and facing the second interior surface of the second panel unit. The recess may be sized to receive therein the first interior surface of the first panel unit with a plane defined by the first exterior surface of the first panel unit substantially flush with a plane defined by the first face of the door.

The door assembly may further comprise a bonding medium to bond to the first interior surface of the first panel unit and to the recess about the opening, wherein the recess is sized to accommodate the bonding medium with the plane defined by the first exterior surface of the first panel unit substantially flush with the plane defined by the first face of the door. The bonding medium may comprise a first medium to structurally support the first panel unit about the opening when bonded to the first panel unit and to the recess, and a second medium to form a vapor barrier between an outer periphery of the first panel unit and the opening of the door. A gap may be defined between an outer periphery of the first panel unit and an end of the recess adjacent to the first face of the door, and the door assembly may further comprise a seal positioned within the gap to form a transition between the outer periphery of the first panel unit and the end of the recess.

Alternatively or additionally, the recess may comprise a first recess surface adjacent to and extending about the opening, and a second recess surface between the first recess surface and the first face of the door, with the door defining a first depth between the first face and the first recess surface and a second depth between the first face and the second recess surface, the second depth greater than the first depth, and wherein the first interior surface of the first panel unit abuts the first recess surface about the opening. The first panel unit may extend beyond the first recess surface toward an end of the recess adjacent to the first face of the door, with the first panel unit terminating at an outer periphery thereof over the second recess surface between the first recess surface and the end of the recess. The door assembly may further comprise a bonding medium positioned between the second surface of the recess and the first interior surface of the first panel unit about the opening of the door, the bonding medium bonding the first interior surface of the first panel unit to the second recess surface such that the door structurally supports the first panel unit. The bonding medium may comprise at least one of an adhesive, a formable medium and a gasket.

Alternatively or additionally, a gap may be defined between the outer periphery of the first panel unit and the end of the recess, and the door assembly may further comprise a seal positioned within the gap to form a transition between the outer periphery of the first panel unit and the end of the recess.

Alternatively or additionally, the door assembly may further comprise a mask positioned between the first interior surface of the first panel unit and the recess about the opening, the mask extending from the outer periphery of the first panel unit toward and over the first recess surface.

Alternatively or additionally, the recess may define a terminal end at an interface between the recess and the first face of the door about the opening, and the recess may be sized to define a gap between the terminal end thereof and an outer periphery of the first panel unit. The terminal end of the recess may define a step between the recess and the first face of the door. The door assembly may further comprise a seal positioned within the gap to form a transition between the outer periphery of the first panel unit and one of the terminal end of the recess and the first face of the door. The seal may comprise at least one of a flexible sealing compound, a semi-flexible sealing compound, a rigid sealing compound and a gasket.

Alternatively or additionally, the door assembly may further comprise at least one of a muntin, one or more decorative panels and one or more conventional blind assemblies positioned between the first panel unit and the second panel unit.

Alternatively or additionally, the door may comprise a foam core surrounded by at least one door skin, and wherein the at least one door skin defines the first and second faces of the door and the recess.

Alternatively or additionally, the first panel unit may be sized larger than the second panel unit such that an outer periphery of the first panel unit extends beyond an outer periphery of the second panel unit, the glazing may further include a spacer secured to the first interior surface of the first panel unit in-board of the outer periphery thereof and to the second interior surface of the second panel unit adjacent to the outer periphery thereof to form an insulated glazing unit, the door may further comprise a frame member extending into the opening about a periphery of the opening, the frame member defining a glazing surface oriented to abut the second exterior surface of the second panel unit, and the frame member may be one of attached to the door and integral with the door such that the frame member and the door are of unitary construction. The door may be devoid of bonding or sealing media between the glazing surface of the frame member and the second exterior surface of the second panel unit.

The first panel unit may comprise a single panel having a first surface defining the first exterior surface of the first panel unit and a second surface opposite the first surface and defining the first interior surface of the first panel unit. The door assembly may further comprise a second panel positioned between the single panel and the second panel unit to define a first space between the first panel and the second panel and a second space between the second panel and the second panel unit, the second panel mounted to the spacer about an outer periphery thereof. Alternatively, the first panel unit may comprise first and second juxtaposed panels separated by and each bonded to a laminating layer to form a laminated glazing, and the first panel may define a first surface defining the first exterior surface of the first panel unit and a second surface opposite the first surface and bonded to the laminating layer, and the second panel may define a third surface defining the first interior surface of the first panel unit and a fourth surface opposite the third surface and bonded to the laminating layer. Alternatively still, the first panel unit may comprise first and second panels separated by and each bonded to a laminated layer to form a laminated glazing unit, the first panel may define a first surface defining the first exterior surface of the first panel unit and a second surface opposite the first surface and bonded to the laminating layer, and the second panel may define a third surface and a fourth surface opposite the third surface and bonded to the laminating layer, the first panel may be sized larger than the second panel such that an outer periphery of the first panel extends beyond an outer periphery of the second panel and the laminating layer extends to the outer periphery of the first panel, and the third surface of the second panel may define the first interior surface of the first panel unit to which the spacer is bonded and the laminating layer may define the first interior surface of the first panel unit received within the recess.

Alternatively or additionally, the recess may define a first recess and the door assembly may further comprise a second recess defined in the second face of the door about the opening, the second recess sized to receive therein the second interior surface of the second panel unit with a plane defined by the second exterior surface of the second panel unit substantially flush with a plane defined by the second face of the door. The door assembly may further comprise a first bonding medium to bond to the first interior surface of the first panel unit and to the first recess about the opening, wherein the first recess is sized to accommodate the first bonding medium with the plane defined by the first exterior surface of the first panel unit substantially flush with the plane defined by the first face of the door, and a second bonding medium to bond to the second interior surface of the second panel unit and to the second recess about the opening, wherein the second recess is sized to accommodate the second bonding medium with the plane defined by the second exterior surface of the second panel unit substantially flush with the plane defined by the second face of the door. The first recess may define a first terminal end at an interface between the first recess and the first face of the door about the opening, the first recess sized to define a first gap between the terminal end thereof and an outer periphery of the first panel unit, and the second recess may define a second terminal end at an interface between the second recess and the second face of the door about the opening, the second recess sized to define a second gap between the terminal end thereof and an outer periphery of the second panel unit. The door assembly may further comprise a first seal positioned within the first gap to form a first transition between the outer periphery of the first panel unit and one of the terminal end of the first recess and the first face of the door, and a second seal positioned within the second gap to form a second transition between the outer periphery of the second panel unit and one of the terminal end of the second recess and the second face of the door. The first panel unit may comprise a single panel having a first surface defining the first exterior surface of the first panel unit and a second surface opposite the first surface and defining the first interior surface of the first panel unit, and the second panel unit may comprise a single panel having a first surface defining the second exterior surface of the second panel unit and a second surface opposite the first surface thereof and defining the second interior surface of the second panel unit. Alternatively, the first panel unit may comprise first and second juxtaposed panels separated by and each bonded to a laminating layer to form a laminated glazing, and the first panel may define a first surface defining the first exterior surface of the first panel unit and a second surface opposite the first surface and bonded to the laminating layer, and the second panel may define a third surface defining the first interior surface of the first panel unit and a fourth surface opposite the third surface and bonded to the laminating layer, and the second panel unit may comprise a single panel having a first surface defining the second exterior surface of the second panel unit and a second surface opposite the first surface thereof and defining the second interior surface of the second panel unit. The glazing may further include a spacer secured to the first interior surface of the first panel unit in-board of an outer periphery thereof and to the second interior surface of the second panel unit in-board of an outer periphery thereof to the outer periphery thereof to form an insulated glazing unit. The door assembly may further comprise at least one of a muntin, one or more decorative panels and one or more conventional blind assemblies positioned between the first panel unit and the second panel unit.

In another aspect, a door assembly may comprise a door defining a first face, a second face opposite the first face, and an opening formed therethrough between the first and second faces, a glazing unit including a panel unit defining an exterior surface and an interior surface opposite the exterior surface, the panel unit defining a thickness between the interior and exterior surfaces thereof, a recess defined in the first face of the door about the opening, and a bonding medium bonded to and between the recess and the interior surface of the panel unit about the recess. The recess may be sized to accommodate the bonding medium and the thickness of the panel unit such that a plane defined by the exterior surface of the panel unit is substantially flush with a plane defined by the first face of the door when the interior surface of the panel unit is bonded to the recess via the bonding medium.

In yet another aspect, a door assembly may comprise a door defining a first face, a second face opposite the first face, and an opening formed therethrough between the first and second faces, a glazing unit including a first panel unit defining a first exterior surface and an first interior surface opposite the first exterior surface, a second panel unit defining a second exterior surface and a second interior surface opposite the second exterior surface, and a spacer secured to and between the first and second interior surfaces to define a space between the first and second panel units, the first panel unit sized larger than the second panel unit such that an outer periphery of the first panel unit extends beyond an outer periphery of the second panel unit, and a recess defined in the first face of the door about the opening. The opening may be sized to receive the second panel unit therein with the first panel unit adjacent to its outer periphery received in the recess, and the recess may be sized such that a plane defined by the first exterior surface of the first panel unit is substantially flush with a plane defined by the first face of the door when the first interior surface of the first panel unit is secured to the recess.

### BRIEF DESCRIPTION OF THE DRAWINGS

FIG. 1A is a cross-sectional view of an embodiment of a door with glazing mounted flush to one face of the door.

FIG. 1B is a cross-sectional view of the embodiment of FIG. 1A shown with an embodiment of a seal positioned between one of the glazing panels and an exposed portion of the recess.

FIG. 1C is a cross-sectional view of the embodiment of FIG. 1A shown with an alternate embodiment of a seal positioned between one of the glazing panels and the exposed portion of the recess.

FIG. 2 is a cross-sectional view of an alternate embodiment of the door and flush-mounted glazing of FIGS. 1A-1C modified to accommodate a laminated glazing panel.

FIG. 3 is a cross-sectional view of yet another alternate embodiment of the door and flush-mounted glazing of FIGS. 1A-1C modified to accommodate an alternate laminated glazing panel.

FIG. 4 is a cross-sectional view of a further alternate embodiment of the door and flush-mounted glazing of FIGS. 1A-1C modified to accommodate a triple-panel glazing.

FIG. 5 is a cross-sectional view of another embodiment of a door with glazing mounted flush to each of the opposing faces of the door.

FIG. 6 is a cross-sectional view of an alternate embodiment of the door and flush-mounted glazing of FIG. 5 modified to accommodate a laminated glazing panel.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

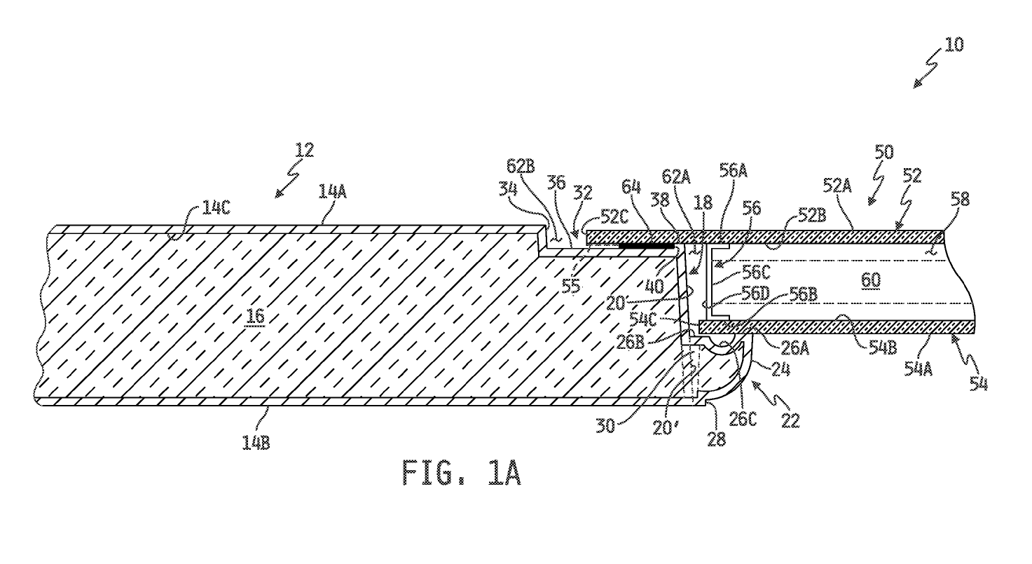

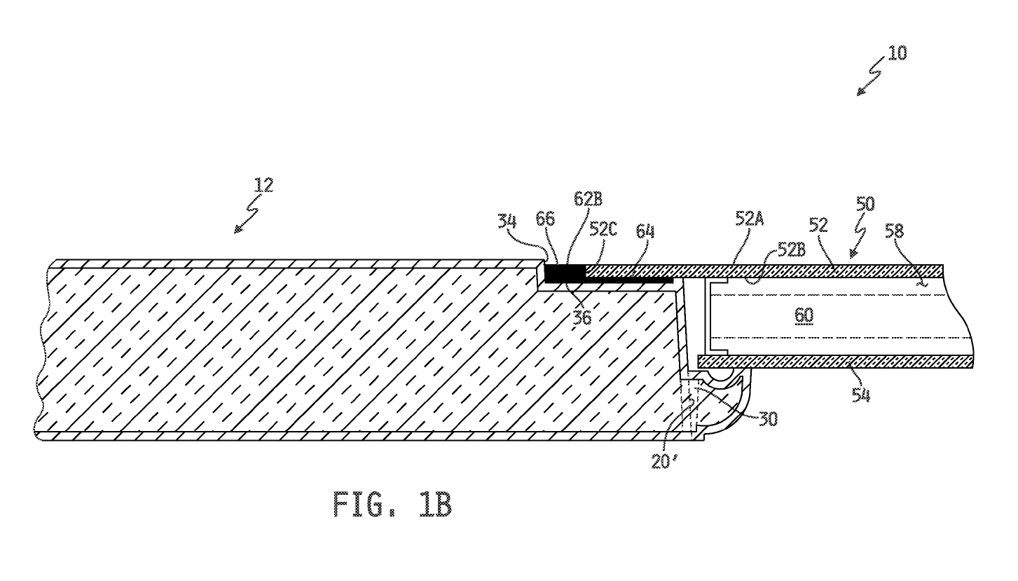

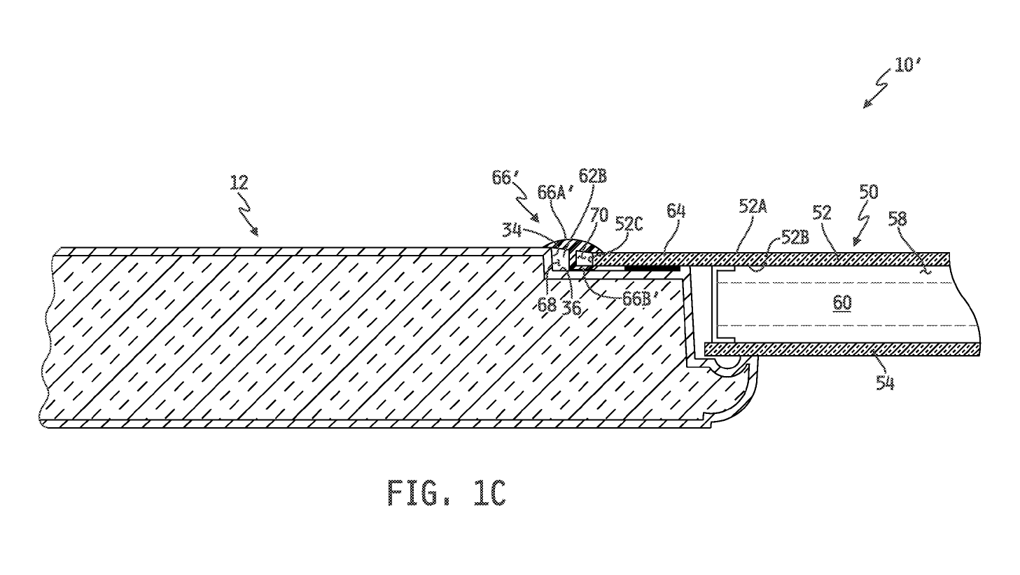

Referring now to FIG. 1A, a cross-sectional view is shown of an embodiment of a door assembly 10 including a door 12 and a glazing 50 mounted flush to one face 14A of the door 12. In the illustrated embodiment, the door 12 is configured to allow the glazing 50 to be mounted within and about an opening 18, defined through the door 12 from one face 14A through an opposite face 14B thereof, in a manner that will allow the glazing 50 to be subsequently replaced with a like-dimensioned glazing. For purposes of this disclosure, the term “glazing” is defined as at least one transparent or translucent panel making up a first glazing panel unit separated perpendicularly to a first plane defined by the first glazing unit by a space from at least one other transparent or translucent panel making up a second glazing panel unit defining a second plane that is parallel to the first plane. The glazing may, in some embodiments, include one or more spacers secured between first and second glazing panel units, and in other embodiments the glazing may not include any such spacers between the first and second glazing panel units but instead rely on the door 12 to structurally support the glazing and/or to supply the space. In embodiments in which at least one of the first and second glazing panel units is provided as a single glazing panel, any such single glazing panel may be formed, at least partially, of glass, and in other embodiments the single glazing panel may be formed of one or more other transparent or translucent materials, examples of which include, but should not be limited to, polycarbonate, polymethyl methacrylate (PMMA) or other conventional glass substitute. In embodiments in which the at least one of the first and second glazing panel units is provided as a multiple-panel glazing panel unit, any such multiple-panel glazing panel unit may be formed of one or more glass and/or glass-substitute panels with one more laminating layers disposed between adjacent panels. In any such embodiment, the multiple-panel glazing panel unit will generally be pre-fabricated such that the multiple panels and one or more laminating layers are adhered or otherwise bonded together to form a single multiple-panel glazing panel unit. In any of the foregoing embodiments, a single or multiple-panel glazing panel unit may be referred to herein as a “glazing panel unit”, any single, transparent or translucent panel defining or forming part of such a glazing panel unit may be referred to herein as a “glazing panel” and the combination of two spaced-apart glazing panel units may be referred to herein generally as a “glazing.” Glazings that include one or more spacers secured to and between two glazing panel units to form a space therebetween may further be referred to herein as an “insulated glazing” or “insulated glazing unit.”

In the embodiment illustrated in FIG. 1, the door 12 includes a foam core 16 surrounded by a door skin 14C. The foam core 16 may illustratively be a polyurethane foam, a phenolic foam or the like, or may alternatively be, or include, one or more other formable, rigid or semi-rigid, vapor resistant or vapor impermeable materials. The door skin 14C may illustratively be or include a metal or metal composite, a natural veneer, e.g., wood or wood composite, a synthetic resin or other synthetic material such as polyvinyl chloride (PVC), glass reinforced plastic (GRP), sheet molding compound or composite (SMC), glass fiber, or the like, although other types of conventional materials may be alternatively or additionally used. In some embodiments, the door skin 14C and the foam core 16 may be bonded or fused together, and one specific example of this, which should not be considered limiting in any way, is the combination of phenolic foam and SMC. As will be described in detail below, the door skin 14C, together with the foam core 16, defines a number of different faces and/or surfaces of the door 12. In some embodiments, the door skin 14C may be a single, unitary door skin which may be worked, fabricated, molded or otherwise formed to define all such number of different faces and/or surfaces. In other embodiments, the door skin 14C may be made up of a number of different, individual door skin sections which may be adhered or otherwise connected together to define a composite door skin 14C.

The opposing door faces 14A, 14B each generally face in opposite directions to each other, such that the plane defined by the door face 14A is substantially parallel to the plane defined by the door face 14B. The opening 18 defined through the door 12 illustratively defines a terminal face 20 generally between the two opposing door faces 14A, 14B. In the embodiment illustrated in FIG. 1A, the terminal face 20 is planar, and the plane defined by the terminal face 20 is substantially perpendicular to the planes defined by each of the opposing door faces 14A, 14B, although this disclosure contemplates alternative embodiments in which the plane defined by the terminal face 20 is non-perpendicular to the planes defined by the opposing door faces 14A, 14B or in which the terminal face 20 is non-planar.

Between the terminal face 20 and the door face 14B, the door 12 defines a frame member 22. The frame member 22 illustratively defines a curved portion 24 that is separated from the door face 14B by another planar terminal face 28 defining a plane that is illustratively parallel to the plane defined by the terminal face 20 but offset from the terminal face 20. It will be understood that the curved portion 24 may be formed to have any desired radius of curvature, or may alternatively be formed in other non-curved or partially curved shapes. Likewise, the terminal face 28 may in some embodiments be co-planar with the terminal face 20 or may be non-planar, and in other embodiments the terminal face 28 may be omitted such that the curved portion terminates at the door face 14B. In any case, the frame member 22 further defines the curved portion 24 and the terminal face 20 of the door 12 a plane surface 26B and a glazing surface 26A separated by a channel 26C. The glazing surface 26A is illustratively planar, and the plane defined by glazing surface 26 is illustratively oriented to be parallel to the planes defined by the opposing door faces 14A, 14B such that the glazing surface 26A may receive in contact an outer surface of a glazing panel unit of the glazing 50. The plane surface 26B is illustratively parallel with the glazing surface 26A and is offset therefrom as illustrated in FIG. 1A, although it will be understood that the plane surface 26B may alternatively be coplanar with the glazing surface 26A, be offset relative to the glazing surface 26A in a direction opposite to that illustrated in FIG. 1A or be non-parallel with the glazing surface 26A. The channel 26C may, in some embodiments be sized to hold a seal, such as a gasket or formable sealing compound, and in other embodiments the channel 26C may remain empty as illustrated in FIG. 1A. In still other embodiments, the channel 26C may be omitted, and the glazing surface 26A and the plane surface 26B may be merged into a single planar surface or two offset planar surfaces.

The frame member 22 extends into the opening 18, e.g., inwardly of or from the terminal face 20 of the door 12, about a periphery of the opening 18. In the embodiment illustrated in FIG. 1A, for example, the glazing surface 26A of the frame member 22 extends substantially perpendicularly away from the terminal face 20 of the door 12 and into the opening 18 about the periphery of the opening 18. In alternate embodiments, the door 12 may be configured such that the frame member 22 extends inwardly into the opening 18 from the door face 14B.

In the embodiment illustrated in FIG. 1, the frame member 22 is integral with the door 12 such that the door 12 and the frame member 22 together form a unitary structure with the foam core 16 extending into the frame member 22 and with the door skin 14C surrounding the foam core 16 and defining the outer surfaces of the various components 24, 26A-26C of the frame member 22. In alternate embodiments, the frame member 22 may be separate from the door 12, and may be mounted to the terminal face 20 of the door 12 and/or to the door face 14B. As illustrated in phantom in FIG. 1A, for example, the terminal face 20 may in an alternate embodiment extend downwardly to form an extension 20′ of the terminal face between the terminal face 20 and the door face 14B, and the frame member 22 may include a mounting structure or surface 30 which may be mounted to the extension 20′ in a conventional manner to affix the frame member 22 to the door 12. In such embodiments, the frame member 22 may be a foam core structure as illustrated in FIG. 1A, or may alternatively be a solid core structure. Those skilled in the art will recognize that in embodiments in which the frame member 22 is separate from the door 12, such a frame member 22 may be mounted, e.g., connected, attached or affixed, to either or both of the terminal face 20 and the door face 14B.

Between the terminal face 20 and the door face 14A, the door 12 defines a recess 32 about the periphery of the opening 18 that is configured to receive therein, and be bonded to, an interior surface of a glazing panel unit, i.e., an interior surface of a glazing panel unit that may include a sole glazing panel or an interior surface of a glazing panel that includes multiple glazing panels, such that a plane defined by an exterior surface of the glazing panel unit is substantially flush, i.e., co-planar, with the plane defined by the door face 14A. Generally, the recess 32 is illustratively sized to accommodate a bonding medium 64 between the recess 32 and the interior surface of the glazing panel unit such that the plane defined by the exterior surface of the glazing panel unit is substantially flush with the plane defined by the door face 14A with the bonding medium 64 bonded to and between the interior surface of the glazing panel unit and the recess 32 such that the door 12 structurally supports the glazing 50. As used herein, the phrase “substantially flush” is defined as co-planar or near co-planar, such that “substantially flush” encompasses embodiments in which the plane defined by the exterior surface of the glazing panel unit is co-planar with the plane defined by the door face 14A, to also encompass embodiments in which the plane defined by the exterior surface of the glazing panel unit is parallel with but slightly offset in either direction from the plane defined by the door face 14A and/or to also encompass embodiments in which the plane defined by the exterior surface of the glazing panel unit is not precisely parallel with, and/or is “slightly offset” in either direction from (i.e., recessed from or proud of), the plane defined by the door face 14A. Illustratively, the phrase “slightly offset” should be understood to include distances from less than 1 millimeter to a few millimeters in the typical case, and up to 20 millimeters in the extreme.

In the illustrated embodiment, for example, the door 12 defines a step 34 from the door face 14A downwardly to one surface 36 of the recess 32, and a step 40 up from the surface 36 to another surface 38 of the recess 32. The surface 38 is thus adjacent to, and extends about, the opening 18 defined through the door 12, and the surface 36 extends between the surface 38 and the door face 14A, and the surfaces 36, 38 are illustratively parallel with each other, perpendicular to the plane defined by the door face 14A and perpendicular to the terminal face 20 of the door 12. The surface 38 defines one depth relative to the plane defined by the door face 14A, the surface 36 defines another depth relative to the plane defined by the door face 14A, and the depth of the surface 36 is greater than the depth of the surface 38. In some embodiments, the recess surface 38 illustratively supports at least one panel of the glazing 50 as will be described in detail below, although it will be understood that in other embodiments the at least one panel of the glazing 50 may be supported by a surface of the recess 32 located elsewhere between the terminal face 20 and the door face 14A or not be supported by any surface of the recess 32 but instead be spaced apart from the recess 32 and be supported by at least one medium, e.g., a bonding medium, positioned within the recess 32.

As illustrated in FIG. 1A, a bonding medium 64 is positioned between the interior surface 52B of the glazing panel 52 (to be described in greater detail below) and the surface 36 of the recess 32. The difference in depths of the surfaces 36, 38 illustratively provides a pocket (surface 36) for the bonding medium 64, and the step 40 illustratively provides a dam to at least partially impede the flow of the bonding medium 64 along the surface 38 and toward the terminal face 20 of the door 12. It will be understood, however, that the step 40 is not required by the illustrated structure, and this disclosure contemplates embodiments in which the step 40 is replaced by a ramp or non-linear transition, and still other embodiments in which the step 40 is omitted and the surfaces 36, 38 are co-planar. It will further be understood that the step 34, in some embodiments, may

In the embodiment illustrated in FIG. 1A, the glazing 50 includes two opposing glazing panel units each in the form of single glazing panels 52 and 54 separated by, and each secured to, a spacer 56 to form an insulated glazing unit 50. The glazing panel 52 has an exterior panel surface 52A and an oppositely facing interior panel surface 52B, and the glazing panel 54 likewise has an exterior panel surface 54A and an interior panel surface 54B. The spacer 56 is conventional and has a planar surface 56A secured, e.g., adhered or otherwise bonded, to the interior surface 52B of the glazing panel 52, and an oppositely facing planar surface 56B secured, e.g., adhered or otherwise bonded, to the interior surface 54B of the glazing panel 54. In the illustrated embodiment, the glazing panel 52 is sized larger than the glazing panel 54 such that an outer periphery of the glazing panel 52 extends beyond the outer periphery of the glazing panel 54. The surface 56B of the spacer 56 is secured to the interior surface 54B of the glazing panel 54 at or near a terminal edge 54C of the glazing panel 54 about a periphery of the glazing panel 54, and the surface 56A of the spacer 56 is secured to the interior surface 52B of the glazing panel 52 in-board of a terminal edge 52C of the glazing panel 52, such that terminal edge 52C of the glazing panel 52 extends beyond the spacer 56 and beyond the terminal edge 54C of the glazing panel 54 about its periphery.

The insulated glazing unit 50 defines a space 58 between the interior surfaces 52B and 54B of the glazing panels 52 and 54 respectively, and between inner surfaces 56C of the spacer 56. The space 58 is, in one embodiment, occupied by a gas, wherein the gas may be air and/or a suitable gas having lower thermal conductivity than that of air, e.g., argon, krypton, xenon, or the like, or may alternatively be evacuated of gas to form a vacuum within the space 58. In any case, the space 58 may be otherwise empty, or may alternatively contain a muntin 60 which may or may not be mounted to the inner surface 56C of the spacer 56. Example muntins 60 may be or include, but are not limited to, one or more grids, one or more metal stampings, or the like. Alternatively or additionally, the structure 60 illustrated within the space 58 in FIG. 1A may be or contain one or more decorative panels, one or more conventional blinds, one or more transparent or translucent panels, or other conventional structure(s). The space 58 may further include a conventional desiccant (not shown), e.g., carried by the inner surface 56C of the spacer 56.

The opening 18 defined through the door 12 is sized to receive the glazing panel 54 of the insulated glazing unit 50 therein as illustrated in FIG. 1A. The glazing surface 26A of the frame member 22 is oriented to receive in direct contact the exterior surface 54A of the glazing panel 54 about the periphery of the glazing panel 54. The recess 32 is sized to receive therein a portion of the glazing panel 52 adjacent to its outer periphery, and more specifically the surface 38 of the recess 32 is sized to receive in direct contact a portion of the interior surface 52A of the glazing panel 52. The bonding medium 64 is generally positioned between the recess 32 and the interior surface 52B of the glazing panel 52, and more specifically the bonding medium is positioned between the recess surface 36 and a corresponding overlaid portion of the interior surface 52B of the glazing panel 52. Illustratively, the interface between the glazing surface 26A of the frame member 22 and the exterior surface 54A of the glazing panel 54 is devoid of any bonding or sealing media, as the bonding medium 64 provides a sufficient structural and moisture proof bond between the insulated glazing unit 50 and the door 12. In alternate embodiments, a conventional sealing and/or bonding medium may be disposed between the glazing surface 26A of the frame member 22 and the outer surface 54A of the glazing panel 54, and/or a conventional sealing medium or structure may be disposed within the pocket or channel 26C to provide a seal between the frame member 22 and the glazing panel 54. In any case, the bonding medium 64 is illustratively provided in the form of a conventional structural adhesive or formable, e.g., curable, bonding medium operable to bond the recess 32 to the interior surface 52B of the glazing panel 52 in an area of the interior surface 52B located between the outer periphery, e.g., terminal edge, 52C of the glazing panel 52 and the recess surface 38, and thereby bond the insulated glazing unit 50 to the door 12 about the periphery of the opening 18 such that the door 12 structurally supports the insulated glazing 50 about a portion of glazing panel 52 near the inner periphery of the glazing panel 52. The bonding medium 64 illustratively further provides a vapor, e.g., moisture, barrier between the environment outside of the door skin 14C and a gap 62A defined between the terminal face 20 of the door, an outer surface 56D of the spacer 56, the glazing surface 26A of the frame member 22 and a portion of the interior surface 52B of the glazing panel 52. In some alternate embodiments, the bonding medium 64 may be provided in the form of multiple separate media; at least one that forms a structural bond between the surface 36 of the recess 32 of the door 12 and the interior surface 52B of the glazing panel 52, and at least one other that forms a vapor barrier between the environment outside of the door skin 14C and the gap 62A and the surfaces exposed to ambient, i.e., external to the door skin 14C, the channel 32, the exterior surface 52A of the glazing panel 52, the terminal edge 52C of the glazing panel 52 and a portion of the interior surface 52B of the glazing panel 52 between the terminal edge 52C and the bonding medium 64. In other alternate embodiments, the bonding medium 64 may be provided in the form of a conventional gasket material along with a conventional structural adhesive or formable bonding medium.

With the insulated glazing unit 50 positioned within and about the opening 18 and secured to the recess 32 of the door 12 as illustrated in FIG. 1A, the gap 62A is defined between the terminal face 20 of the door, an outer surface 56D of the spacer 56, the glazing surface 26A of the frame member 22 and the interior surface 52B of the glazing panel 52. In one embodiment, a masking layer 55 may be applied to the interior surface 52B of the glazing panel 52 about and adjacent to the periphery of the glazing panel 52, or may otherwise be provided between the interior surface 52B of the glazing panel 52 and the recess 32, for the purpose of at least partially hiding the recess 32, including the bonding medium 64, and in some embodiments to also at least partially hide the gap 62A, from view externally to the insulated glazing unit 50. Examples of materials that may be used to form the masking layer 55 may include, but should not be limited to, any one or more of a conventional frit layer, a conventional paint and a conventional tint material.

Another gap 62B is defined between the terminal edge 52C of the glazing panel 54 and the step 34 of the recess 32 about the periphery of the recess 32, i.e., between the terminal edge 52C of the glazing panel 52 and the door face 14. As illustrated by example in FIGS. 1B and 1C, a conventional seal 66, 66′ may be disposed in the gap 62B to provide an aesthetic transition between the terminal edge 52C of the glazing panel 52 and either the terminal end of the recess 32 defined by the step 34 or the door face 14. The seal 66, 66′ may illustratively be or include, for example, one or more of a conventional flexible sealing compound, a semi-flexible sealing compound, a rigid (e.g., formable) sealing compound and a gasket. In the embodiment illustrated in FIG. 1B, for example, the seal 66 is provided in the form of a conventional caulk or other formable medium that may be applied before or after the insulated glazing unit 50 is set into the opening 18 as described above. In an alternate embodiment 10′, as illustrated in FIG. 1C, the seal 66′ may be provided in the form of a conventional gasket material. In the embodiment illustrated in FIG. 1C, the seal 66′ includes a head 66A′ coupled to a flexible or semi-flexible shaft 66B′, and the shaft 66B′ of the seal 66′ is forced into the space between the interior surface 52B of the glazing panel 52 and the surface 36 of the recess 32 until the head 66A′ abuts the exterior surface 52A of the glazing panel 52. Air gaps 68 and 70 are illustratively formed about the gasket 66′. The embodiment 10′ illustrated in FIG. 1C is otherwise identical to that illustrated in FIGS. 1A and 1B, and may therefore include any feature illustrated and described with respect to FIGS. 1A and 1B regardless of whether any such feature is specifically illustrated in FIG. 1C.

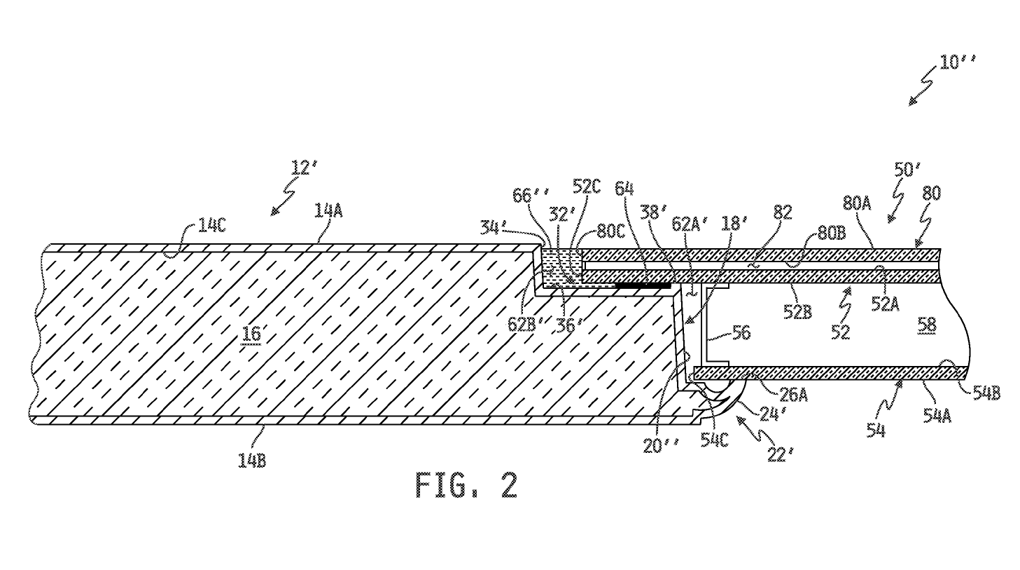

In the embodiment illustrated in FIGS. 1A-1C, the glazing panel units of the glazing 50 are each provided in the form of single glazing panels 52, 54. In alternate embodiments, either or both of the glazing panel units may be provided in the form of multiple glazing panels. An example of one such embodiment 10″ is illustrated in FIG. 2, wherein the glazing panel unit that abuts the glazing surface 26A of the door 12′ is provided in the form of the single glazing panel 54 as described above, and the opposite glazing panel unit is formed by the glazing panel 52 separated from and bonded to a second glazing panel 80 via a conventional laminating layer 82. More specifically, the exterior surface 52A of the glazing panel 52 is bonded by the laminating layer 82 to an interior surface 80B of the second glazing panel 80 to form a conventional storm or hurricane glazing. In one embodiment, the laminating layer 82 is illustratively a flexible bonding medium configured to hold together the various pieces of the glazing panel 52 and/or 80 if broken and the glazing panel unit 52, 80 is dislodged or removed from the opening, and/or to act as an air and/or moisture barrier within the opening 18 if the glazing panel 52 and/or 80 is broken and the glazing panel unit 52, 80 remains in the opening 18. In alternate embodiments, the laminating layer 82 may illustratively be or include one or more conventional materials that prevents or at least inhibits breakage of the glazing panel 52 and/or 80.

In any case, the glazing panels 52 and 80 in the illustrated embodiment are identically sized such that the panels 52 and 80 are juxtaposed and their terminal edges 52C, 80C co-terminate. Modifications to the door 12′ to accommodate the multiple-panel glazing panel unit 52, 80 require the depth of the channel 32′ to be increased such that a plane defined by the outer surface 80A, when the resulting insulated glazing unit 50′ is mounted to the door 12′, is substantially flush with the plane defined by the door face 14A. It will be understood that while the multiple-panel glazing unit 52, 80 is illustrated in FIG. 2 with two glazing panels, the multiple-panel glazing 52, 80 may alternatively include any number of panels, and any modifications to the door 12′ to accommodate such glazing would be a mechanical step for a skilled artisan. Likewise, while the opposite glazing panel unit is illustrated in FIG. 2 in the form of a single glazing panel 54, this glazing panel unit may alternative include any number of glazing panels, and any modifications to the door 12′ to accommodate such glazing would be a mechanical step for a skilled artisan. The seal 66″ illustrated in FIG. 2 may be identical to the seal 66 illustrated and described with respect to FIG. 1B, although the seal 66″ will necessarily have a larger volume than that of the seal 66 due to the increased depth of the recess 32′. Alternatively or additionally, a seal of the type 66′ illustrated in FIG. 1C may be used. In any case, the embodiment 10″ illustrated in FIG. 2 is otherwise identical to that illustrated in FIGS. 1A-1C, and may therefore include any feature illustrated and described with respect to FIGS. 1A-1C regardless of whether any such feature is specifically illustrated in FIG. 2.

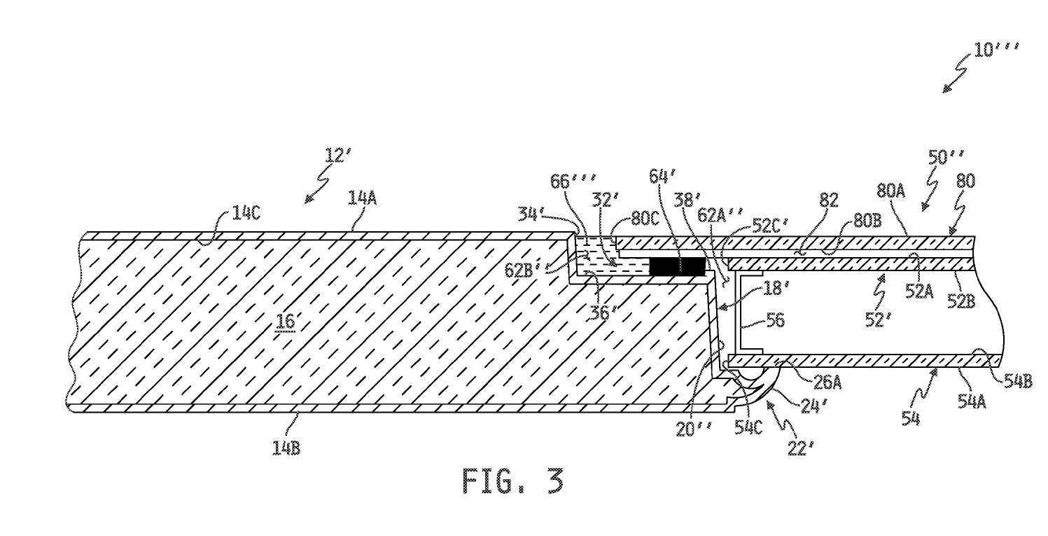

Another example embodiment 10′″ is illustrated in FIG. 3, which includes a modified version of the multiple-panel glazing panel unit 52, 80 illustrated in FIG. 2 but which may otherwise be identical to the embodiment 10″ illustrated in FIG. 2. In the embodiment 10′″ illustrated in FIG. 3, for example, the glazing panel 52′ is separated from the second glazing panel 80 by a conventional laminating layer 82 as illustrated in FIG. 2, but in this embodiment the bonding medium 64 bonds the recess 32′ directly to the laminating layer 82. More specifically, in the embodiment illustrated in FIG. 3, the sizing of the glazing panel 52′ is modified such that the surface 56A of the spacer 56 is secured to the interior surface 52B of the glazing panel 52′ at or near the terminal edge 52C′ of the glazing panel 52′ about a periphery of the glazing panel 52′. This exposes the laminating layer 82 between the terminal edge 52C′ of the glazing panel 52′ and the terminal edge 80C of the glazing panel 80. Alternatively, the laminating layer 82 may be omitted from the portion of the glazing panel 80 that extends over the recess 32′, in which case the bonding medium 64 bonds the recess 32′ directly to the interior surface 80B of the glazing panel 80. In either case, the recess 32′ may be modified from the recess 32 illustrated in FIGS. 1A-2 such that the portion of the glazing panel unit 52′, 80 that contacts the medium 64 may not directly contact any part of the recess 32′ as illustrated in FIG. 3, or the recess 32′ may alternatively be configured like the recess 32 or otherwise modified such that a portion of the glazing panel unit 52′, 80 adjacent to that which contacts the medium 64 also abuts one or more surfaces of the recess 32′.

In any case, modifications to the door 12″ to accommodate the modified insulated glazing unit 50″ require the depth of the recess 32″ to be reduced relative to that illustrated in FIG. 2 such that the plane defined by the outer surface 80A of the glazing panel 80, when the resulting insulated glazing unit 50″ is mounted to the door 12″, is substantially flush with the plane defined by the door face 14A. This will typically result in a reduced-length terminal face 20′″ of the door 12″ relative to the terminal face 20″ of the door 12′ illustrated in FIG. 2, although modifications to the door 12″ may alternatively be accomplished in a manner that does not modify the length of the terminal face 20′″ relative to the terminal face 20″. As with the embodiment illustrated in FIG. 2, it will be understood that while the multiple-panel glazing panel unit 52′, 80 is illustrated in FIG. 3 with two glazing panels, the multiple-panel glazing panel unit 52′, 80 may alternatively include any number of glazing panels, and any modifications to the door 12″ to accommodate such glazing would be a mechanical step for a skilled artisan. And while the opposite glazing panel unit is illustrated in FIG. 3 in the form of a single glazing panel 54, this glazing panel unit may alternative include any number of glazing panels, and any modifications to the door 12′ to accommodate such glazing would likewise be a mechanical step for a skilled artisan. The seal 66′″ illustrated in FIG. 3 may be identical to the seal 66 illustrated and described with respect to FIG. 1B, although the seal 66′″ will necessarily have a larger volume than that of the seal 66 due to the increased depth of the recess 32′ (and will have a lesser volume than that of the seal 66″ illustrated in FIG. 2 due to the decreased depth of the recess 32′). Alternatively or additionally, a seal of the type 66′ illustrated in FIG. 1C may be used. In any case, the embodiment 10′″ illustrated in FIG. 3 is otherwise identical to that illustrated in FIGS. 1A-1C, and may therefore include any feature illustrated and described with respect to FIGS. 1A-1C regardless of whether any such feature is specifically illustrated in FIG. 3.

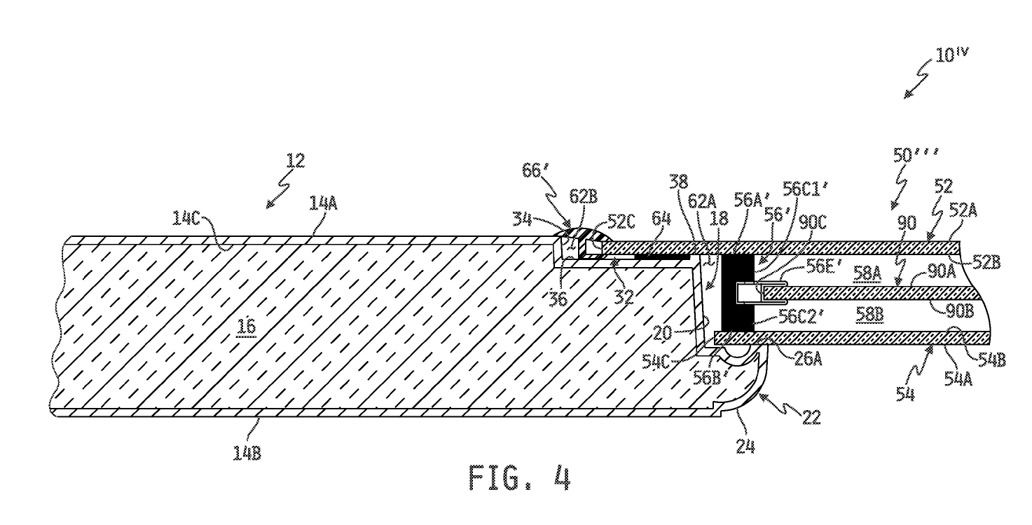

In the embodiment illustrated in FIGS. 1A-1C, the insulated glazing unit 50 is provided in the form of two glazing panel units 52 and 54 separated by a space 58. In alternate embodiments, the glazing unit may include three or more glazing panel units, and any one or more of the three or more glazing panel units may be provided in the form of a single glazing panel or a multi-layer glazing panel. An example of one such embodiment 10^{iv} is illustrated in FIG. 4, in which the insulated glazing unit 50′″ includes a third glazing panel unit, provided in the form of a single glazing panel 90, positioned between the outer glazing panel units and which, in the embodiment illustrated in FIG. 4, are each provided in the form of a single glazing panel 52 and 54 respectively. More specifically, the spacer surface 56C in the embodiment illustrated in FIG. 4 includes two spacer surfaces 56C1′ and 56C2′ separated by a spacer structure 56E′, wherein the terminal edge of the glazing panel 90 is received by and secured to the spacer structure 56E′. The interior surface 54B of the glazing panel 54 and a surface 90B of the glazing panel 90 opposite the surface 90A are secured to the spacer 56′ at or near the terminal edges 54C and 90C of the glazing panels 54 and 90. The terminal edge 52C of the glazing panel 52 extends beyond the spacer 56′ as described above with respect to FIG. 1A. The space 58 between the glazing panel units 52 and 54 is thus divided, e.g., substantially equally, into two sub-spaces; a sub-space 58A bounded by the inner surface 52B of the glazing panel unit 52, the surface 90A of the glazing panel 90 and the inner surface 56C1′ of the spacer 56′, and a sub-space 58B bounded by the inner surface 54B of the glazing panel unit 54, the surface 90B of the glazing panel 90 and the inner surface 56C2′ of the spacer 56′. The spaces 58A, 58B may be occupied by a gas, or each by different gases, examples of which are described above, or either or both of the spaces 58A, 58B may be evacuated of gas to form a vacuum therein. In any case, the spaces 58A, 58B may be otherwise empty, or may alternatively contain a muntin 60 or other suitable structure.

Modifications to the door 12′″ to accommodate the triple-panel insulated glazing unit 50^{iv} may require an increased length terminal face 20 of the door 12 relative to the terminal face 20 of the door 12 illustrated in FIGS. 1A-1C, although any required modifications to the door 12 to accommodate the insulated glazing unit 50′″, if required at all, may alternatively be accomplished in a manner that does not modify the length of the terminal face 20. The seal 66′ illustrated in FIG. 4 may be identical to the seal 66′ illustrated and described with respect to FIG. 1C. Alternatively or additionally, a seal of the type 66 illustrated in FIG. 1B may be used. In any case, the embodiment 10^{iv} illustrated in FIG. 4 is otherwise identical to that illustrated in FIGS. 1A-1C, and may therefore include any feature illustrated and described with respect to FIGS. 1A-1C regardless of whether any such feature is specifically illustrated in FIG. 4.

In the embodiments illustrated in FIGS. 1A-4, the insulated glazing units 50, 50′, 50″ and 50′″ may be replaced within the door 12, 12′, 12″, e.g., without having to replace the combination of the door 12, 12′, 12″, and the insulated glazing unit 10, 10′, 10″, 10′″, 10^{iv}. For example, a conventional tool may be used to cut through or otherwise separate the bonding medium 64 from itself, from the inner surface 52B of the glazing panel unit 52 and/or from the recess 32. In embodiments in which no bonding medium is disposed between the outer surface 54A of the glazing panel unit 54 and the glazing surface 26A of the frame member 22, as illustrated in each of FIGS. 1A-4, the entire insulated glazing unit 50, 50′, 50″ and 50′″ may then be removed from the opening 18. In embodiments in which a bonding medium is disposed between the outer surface 54A of the glazing panel unit 54 and the glazing surface 26A of the frame member 22, such bonding medium may similarly be cut or otherwise separated from itself, from the outer surface 54A of the glazing panel unit 54 and/or from the glazing surface 26A of the frame member 22, and the entire insulated glazing unit 50, 50′, 50″ and 50′″ may then be removed from the opening 18. In either case, another insulated glazing unit 50, 50′, 50″ and 50′″ may then be inserted into the opening 18 and secured into place via a fresh application of the bonding medium 64 or other suitable bonding media as described above, without having to at least partially disassemble the door 12, 12′ 12″, and the insulated glazing unit 50, 50′, 50″ and 50′″ can then be finished off with a seal 66, 66′, 66″, 66′″ as described above.

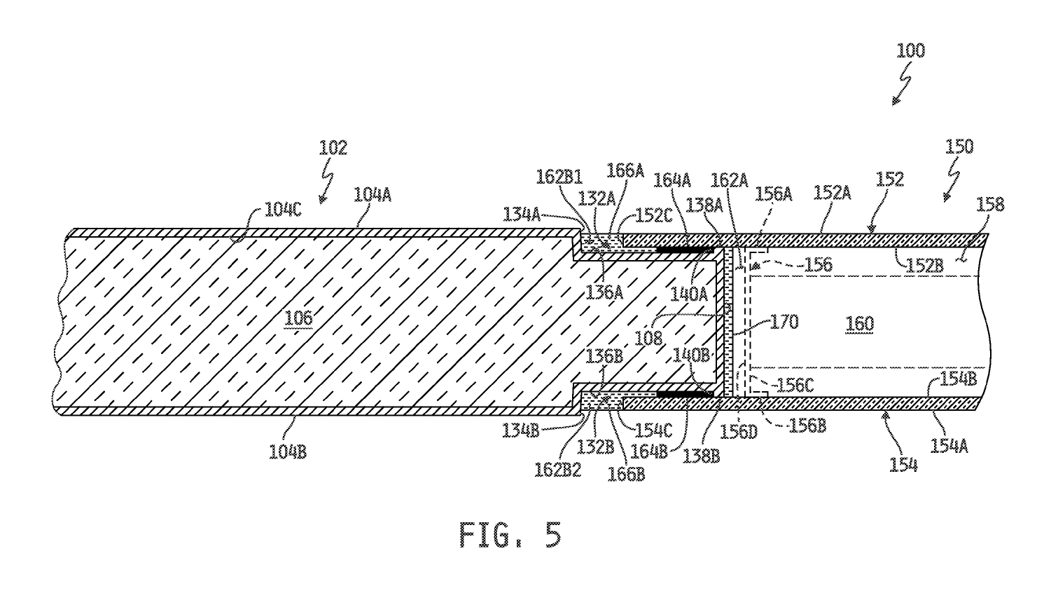

Referring now to FIG. 5, a cross-sectional view is shown of another embodiment of a door assembly 100 including a door 102 and a glazing unit 150 mounted flush to each of two opposing faces 104A and 104B of the door 102. In the illustrated embodiment, the door 102 includes a foam core 106 surrounded by a single or multiply-connected door skins 104C as described above with respect to FIGS. 1A-1C. The door face 104A defines a recess 132A and the door face 104B defines a recess 132B, wherein each of the recesses 132A and 132B are identically as described above with respect to FIGS. 1A-1C and are identified by like numbers offset by 100. For example, the recess 132A defines a step 134A downwardly from the door face 104A to a recess surface 136, and another step 140A up to a second recess surface 138A, wherein the depth of the surface 132A relative to the door face 104A is greater than that of the surface 138. Likewise, the recess 132B defines a step 1134B downwardly from the door face 104B to a recess surface 136B, and another step 140B up to a second recess surface 138B, wherein the depth of the recess surface 136B relative to the door face 104B is greater than that of the recess surface 138B. Between the two recesses 132A, 132B, the door 102 defines a terminal surface 108. It will be understood that while the recesses 132A, 132B are illustrated and described as being identical in structure and size, one of the recesses 132A, 132B may alternatively be different, in structure and/or size, than the other recess 132B, 132A.

The glazing unit 150 includes a glazing panel unit 152 and a glazing panel unit 154, wherein the glazing panel units 152, 154 are positionable opposite one another and spaced apart from one another as illustrated and described with respect to the glazing unit 50 of FIGS. 1A-1C. In the illustrated embodiment, the glazing panel unit 154 is provided in the form of a single glazing panel 152, and the glazing panel unit 154 is likewise provided in the form of a single glazing panel 154. The glazing panel 152 has an interior surface 152B bonded to the recess 132A via a bonding medium 164A such that a plane defined by the exterior surface 152A is substantially flush with the plane defined by the door face 104A. The glazing panel 154 likewise has an interior surface 154B bonded to the recess 132B via a bonding medium 164B such that a plane defined by an exterior surface 154A of the glazing panel 154 is substantially flush with the plane defined by the door face 104B. The bonding media 164A, 164B may, but need not, be as described above with respect to FIGS. 1A-1C, and/or the bonding medium 164A may be different in composition from the bonding medium 164B. In any case, a conventional desiccant 170 is illustratively disposed in the space 158 defined between the two glazing panels 152, 154, and in the illustrated embodiment the desiccant 170 is applied to or otherwise carried by the terminal face 108 of the door 102. As with the embodiment illustrated in FIGS. 1A-1C, a seal 166A is disposed in the gap 162B1 defined between the terminal edge 152C of the glazing panel 152 and either the step 134A or the door face 104A, and a seal 166B is disposed in the gap 162B2 defined between the terminal edge 154C of the glazing panel 154 and either the step 134B or the door face 104B. The seals 166A, 166B may, but need not, be identical to each other and either may take any of the forms illustrated and described above with respect to FIGS. 1A-4.

In an alternate embodiment, the glazing panel units 152 and 154 may be secured together via a conventional spacer, as described above, and an example spacer 156 is illustrated in phantom in FIG. 5. In such embodiments, the glazing unit 150 will typically be provided as a preassembled or pre-fabricated unit and the door 102 will then typically be constructed around the preassembled glazing unit 150. In such embodiments, the glazing unit 150 may further include a muntin 160, shown in phantom in FIG. 5, which may take or include any one or more of the forms described above.

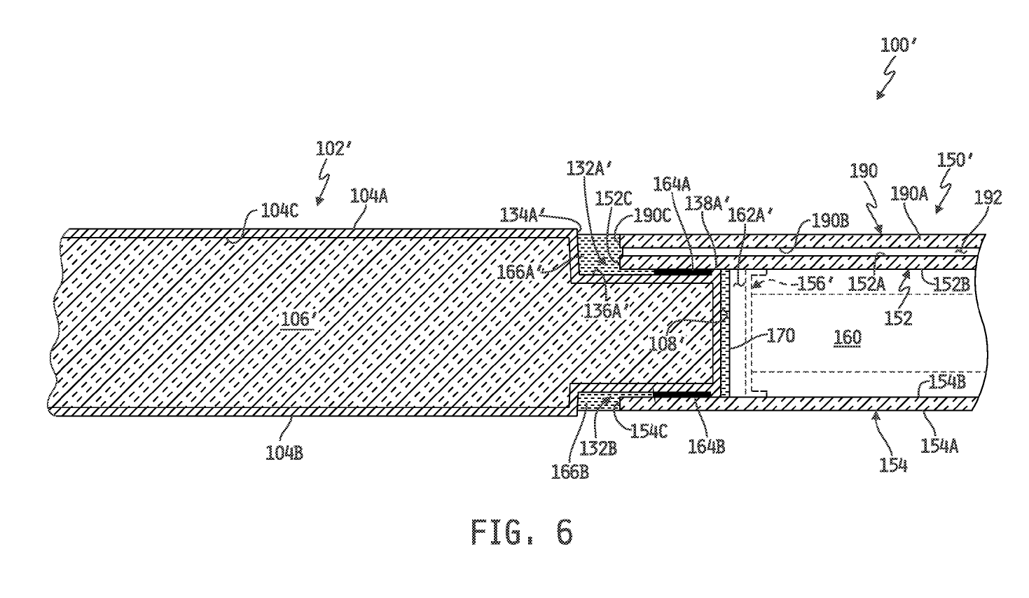

Referring now to FIG. 6, an alternate embodiment 100′ of the door assembly 100 is shown in which one of the glazing panel units of the glazing unit 150 is replaced with a multiple-panel glazing unit to form a modified glazing unit 150′. In the illustrated embodiment, for example, the exterior surface 152A of the glazing panel 152 is bonded by a laminating layer 192 to an interior surface 190B of a second glazing panel 190 to form a conventional storm or hurricane glazing. The laminating layer 192 is illustratively the same as that described above with respect to FIG. 2. Illustratively, and as with the embodiment illustrated in FIG. 2, the glazing panels 152 and 190 are identically sized such that the panels 152 and 190 are juxtaposed and their terminal edges 152C, 190C co-terminate. In alternative embodiments, a portion of the panel 152 and/or laminating layer 192 that extends over the recess 132A′ may be omitted such that the recess 132A′ is bonded directly to the laminating layer 192 or to the interior surface 190B of the glazing panel 190 as illustrated and described above with respect to FIG. 3. Modifications to the door 102′ to accommodate the multiple-panel glazing unit 152, 190 require the depth of the channel 132A′ to be increased such that the outer surface 190A, when the resulting insulated glazing unit 150′ is mounted to the door 102′, is substantially flush with the door face 104A. It will be understood that while the multiple-panel glazing unit 152, 190 is illustrated in FIG. 6 with two glazing panels, the multiple-panel glazing may alternatively include any number of panels, and any modifications to the door 102′ to accommodate such glazing would be a mechanical step for a skilled artisan. And while the opposite glazing panel unit is illustrated in FIG. 6 in the form of a single glazing panel 154, this glazing panel unit may alternatively include any number of glazing panels, and any modifications to the door 102′ to accommodate such glazing would likewise be a mechanical step for a skilled artisan. The seals 166A, 166B illustrated in FIGS. 5 and 6 may be identical to the seal 66, 66″, 66′″ illustrated and described with respect to FIGS. 1B, 2 and 3 respectively. Alternatively or additionally, a seal of the type 66′ illustrated in FIGS. 1C and 4 may be used. In any case, the embodiments 100, and 100′ illustrated in FIGS. 5-6 may include any feature illustrated and described with respect to any of FIGS. 1A-4 regardless of whether any such feature is specifically illustrated in any of FIGS. 5-6.

In the embodiments illustrated in FIGS. 5 and 6, i.e., in which no spacer 156 and 156′ or other structure secures the inner surface 152B of the glazing panel unit 152 to the inner surface 154B of the glazing panel unit 154, the glazings 100, 100′ may be replaced, in whole or in part, within the door 102, 102′, e.g., without having to replace the combination of the door 102, 102′ and the entire glazing 100, 100″. For example, a conventional tool may be used to cut through or otherwise separate the bonding media 164A and/or 164B from itself, from the inner surface 152B, 154B of the glazing 152, 154 and/or from the recess 132A, 132B. The glazing 152 and/or 154, or the combination of glazings 152, 190 and laminate 192, may then be removed from the opening 108, and another glazing 152 and/or 154, or the combination of glazings 152, 190 and laminate 192, may then be inserted into the opening 108 and secured into place via a fresh application of the bonding media 164A, 164B or other suitable bonding media as described above, and the insulated glazing unit 100, 100′ can then be finished off with seals 166A, 166B or gaskets as described above. In embodiments in which the inner surfaces of the glazing panel units 152 and 154 are secured together, e.g., via one or more spacers, however, such replacement generally cannot be accomplished without at least partially disassembling the door 102, 102′.

In the various embodiments 10, 10′, 10″, 10^{iv} illustrated and described herein, one of the glazing panel units of a two-panel glazing unit is mounted to and within a recess formed in one face of the door about an opening formed through the door. In each embodiment, the recess is sized to accommodate a thickness of the glazing panel unit, defined between an interior surface and an oppositely-facing exterior surface thereof, and to also accommodate a bonding medium between the recess and the interior surface of the glazing panel unit such that a plane defined by an exterior surface of the glazing panel unit is substantially flush with a plane defined by the one face of the door when the interior surface of the glazing panel unit is bonded to and between the recess via the bonding medium. In the various embodiments 100, 100′ illustrated and described herein, one glazing panel unit of a two-panel glazing unit is mounted to and within a first recess formed in one face of the door about an opening formed through the door and the other glazing panel unit is likewise mounted to and within a second recess formed in an opposite face of the door about the opening. Each recess is sized to accommodate a thickness of a different one of the glazing panel units, defined between an interior surface and an oppositely-facing exterior surface thereof, which may or may not be equal, and to also accommodate a bonding medium between the recess and the interior surface of the glazing panel unit such that a plane defined by an exterior surface of the glazing panel unit is substantially flush with a plane defined by the corresponding face of the door when the interior surface of the glazing panel unit is bonded to and between the recess via the bonding medium.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, while the various embodiments illustrated and described herein include a glazing unit having two oppositely facing glazing panel units, the concepts illustrated and described herein are equally applicable to single glazing panel units. Thus, for example, the structures and methods illustrated and described herein may be used to flush-mount a single glazing panel unit, which may include a single glazing panel or multiple glazing panels, to and over a door opening which may or may not include any additional glazing panel units. As another example, while the embodiments illustrated in FIGS. 2 and 3 that include a “hurricane glazing” e.g., a glazing panel unit having two glazing panels separated by a laminating layer (or more than two glazing panels each separated by a different laminating layer), are shown and described as having such a glazing panel unit 52, 80 mounted with the plane defined by the exterior surface 80A of the glazing panel 80 substantially flush with the face 14A of the door 12, it will be understood that in alternate embodiments the glazing unit may be reversed such that the glazing panel unit 52, 80 is mounted to the frame member 22′ (e.g., to the glazing surface 26A of the frame member 22′). In such embodiments, the glazing panel unit 52, 80 will typically be structurally mounted to the door 12′ via a bonding medium, e.g., bonding medium 64, bonded to and between the frame member 22′ and the glazing panel unit 52, 80, and the bonding medium 64 shown in the recess 32′ may, but need not, be omitted. As a related example, while the embodiment illustrated in FIG. 6 that includes a glazing panel unit having two glazing panels separated by a laminating layer (or more than two glazing panels each separated by a different laminating layer) is shown and described as having such a glazing panel unit 152, 190 mounted with the plane defined by the exterior surface 190A of the glazing panel 190 substantially flush with the face 104A of the door 102′, it will be understood that in alternate embodiments the glazing unit may be reversed such that the glazing panel unit 152, 190 is mounted with the plane defined by the exterior surface 190A of the glazing panel 190 substantially flush with the face 1046 of the door 102′. In embodiments in which the glazing unit does not include a hurricane glazing, either or both of the glazing panel units may be bonded to the door 12, 12′, 12, 102, 102′ to the exclusion or inclusion of the other glazing panel unit.

1. A door assembly comprising:
a door defining a first face, a second face opposite the first face, and an opening formed therethrough between the first and second faces,
a glazing mounted to at least the first face of the door about the opening, the glazing including a first panel unit defining a first exterior surface and a first interior surface opposite the first exterior surface, and a second panel unit defining a second exterior surface and a second interior surface opposite the second exterior surface, the first interior surface of the first panel unit spaced apart from and facing the second interior surface of the second panel unit, and
a recess defined in the first face of the door about the opening, the recess sized to receive therein the first interior surface of the first panel unit with a plane defined by the first exterior surface of the first panel unit substantially flush with a plane defined by the first face of the door.

2. The door assembly of claim 1 further comprising a bonding medium to bond to the first interior surface of the first panel unit and to the recess about the opening,
wherein the recess is sized to accommodate the bonding medium with the plane defined by the first exterior surface of the first panel unit substantially flush with the plane defined by the first face of the door.

3. The door of claim 2 wherein the bonding medium comprises a first medium to structurally support the first panel unit about the opening when bonded to the first panel unit and to the recess, and a second medium to form a vapor barrier between an outer periphery of the first panel unit and the opening of the door.

4. The door assembly of claim 2 wherein a gap is defined between an outer periphery of the first panel unit and an end of the recess adjacent to the first face of the door,
and further comprising a seal positioned within the gap to form a transition between the outer periphery of the first panel unit and the end of the recess.

5. The door assembly of claim 1 wherein the recess comprises a first recess surface adjacent to and extending about the opening, and a second recess surface between the first recess surface and the first face of the door, the door defining a first depth between the first face and the first recess surface and a second depth between the first face and the second recess surface, the second depth greater than the first depth,
and wherein the first interior surface of the first panel unit abuts the first recess surface about the opening and the first panel unit extends beyond the first recess surface toward an end of the recess adjacent to the first face of the door, the first panel unit terminating at an outer periphery thereof over the second recess surface between the first recess surface and the end of the recess,
and wherein the door assembly further comprises a bonding medium positioned between the second recess surface and the first interior surface of the first panel unit about the opening of the door, the bonding medium bonding the first interior surface of the first panel unit to the second recess surface such that the door structurally supports the first panel unit.

6. (canceled)

7. (canceled)

8. (canceled)

9. The door assembly of claim 5 wherein a gap is defined between the outer periphery of the first panel unit and the end of the recess,
and further comprising at least one of a seal positioned within the gap to form a transition between the outer periphery of the first panel unit and the end of the recess and a mask positioned between the first interior surface of the first panel unit and the recess about the opening, the mask extending from the outer periphery of the first panel unit toward and over the first recess surface.

10. (canceled)

11. The door assembly of claim 4 wherein the recess defines a terminal end at an interface between the recess and the first face of the door about the opening,
and wherein the recess is sized to define the gap between the terminal end thereof and the outer periphery of the first panel unit,
and wherein the seal is positioned within the gap to form a transition between the outer periphery of the first panel unit and one of the terminal end of the recess and the first face of the door,
and wherein the seal comprises at least one of a flexible sealing compound, a semi-flexible sealing compound, a rigid sealing compound and a gasket.

12. (canceled)

13. (canceled)

14. (canceled)

15. The door assembly of claim 1 further comprising at least one of a muntin, one or more decorative panels and one or more conventional blind assemblies positioned between the first panel unit and the second panel unit.

16. The door assembly of claim 1 wherein the door comprises a foam core surrounded by at least one door skin, and wherein the at least one door skin defines the first and second faces of the door and the recess.

17. The door assembly of claim 1 wherein the first panel unit is sized larger than the second panel unit such that an outer periphery of the first panel unit extends beyond an outer periphery of the second panel unit,
wherein the glazing further includes a spacer secured to the first interior surface of the first panel unit in-board of the outer periphery thereof and to the second interior surface of the second panel unit adjacent to the outer periphery thereof to form an insulated glazing unit,
and wherein the door further comprises a frame member extending into the opening about a periphery of the opening, the frame member defining a glazing surface oriented to abut the second exterior surface of the second panel unit,
and wherein the frame member is one of attached to the door and integral with the door such that the frame member and the door are of unitary construction.

18. The door assembly of claim 17 wherein the door is devoid of bonding or sealing media between the glazing surface of the frame member and the second exterior surface of the second panel unit.

19. The door assembly of claim 17 wherein the first panel unit comprises a single panel having a first surface defining the first exterior surface of the first panel unit and a second surface opposite the first surface and defining the first interior surface of the first panel unit.

20. The door assembly of claim 19 further comprising a second panel positioned between the single panel and the second panel unit to define a first space between the single panel and the second panel and a second space between the second panel and the second panel unit, the second panel mounted to the spacer about an outer periphery thereof.

21. The door assembly of claim 17 wherein the first panel unit comprises first and second juxtaposed panels separated by and each bonded to a laminating layer to form a laminated glazing,
and wherein the first panel defines a first surface defining the first exterior surface of the first panel unit and a second surface opposite the first surface and bonded to the laminating layer, and the second panel defines a third surface defining the first interior surface of the first panel unit and a fourth surface opposite the third surface and bonded to the laminating layer.

22. The door assembly of claim 17 wherein the first panel unit comprises first and second panels separated by and each bonded to a laminated layer to form a laminated glazing unit,
and wherein the first panel defines a first surface defining the first exterior surface of the first panel unit and a second surface opposite the first surface and bonded to the laminating layer, and the second panel defines a third surface and a fourth surface opposite the third surface and bonded to the laminating layer,
and wherein the first panel is sized larger than the second panel such that an outer periphery of the first panel extends beyond an outer periphery of the second panel and the laminating layer extends to the outer periphery of the first panel,
and wherein the third surface of the second panel defines the first interior surface of the first panel unit to which the spacer is bonded and the laminating layer defines the first interior surface of the first panel unit received within the recess.

23. The door assembly of claim 11 wherein the recess defines a first recess, the gap defines a first gap, and the bonding medium defines a first bonding medium, and further comprising:
a second recess defined in the second face of the door about the opening, the second recess sized to receive therein the second interior surface of the second panel unit with a plane defined by the second exterior surface of the second panel unit substantially flush with a plane defined by the second face of the door, the second recess defining a second terminal end at an interface between the second recess and the second face of the door about the opening, the second recess sized to define a second gap between the terminal end thereof and an outer periphery of the second panel unit,
a second bonding medium to bond to the second interior surface of the second panel unit and to the second recess about the opening, wherein the second recess is sized to accommodate the second bonding medium with the plane defined by the second exterior surface of the second panel unit substantially flush with the plane defined by the second face of the door, and
a second seal positioned within the second gap to form a second transition between the outer periphery of the second panel unit and one of the terminal end of the second recess and the second face of the door.

24. (canceled)

25. (canceled)

26. (canceled)

27. The door assembly of claim 23 wherein the first panel unit comprises a single panel having a first surface defining the first exterior surface of the first panel unit and a second surface opposite the first surface and defining the first interior surface of the first panel unit,
and wherein the second panel unit comprises a single panel having a first surface defining the second exterior surface of the second panel unit and a second surface opposite the first surface thereof and defining the second interior surface of the second panel unit.

28. The door assembly of claim 23 wherein the first panel unit comprises first and second juxtaposed panels separated by and each bonded to a laminating layer to form a laminated glazing,
and wherein the first panel defines a first surface defining the first exterior surface of the first panel unit and a second surface opposite the first surface and bonded to the laminating layer, and the second panel defines a third surface defining the first interior surface of the first panel unit and a fourth surface opposite the third surface and bonded to the laminating layer,
and wherein the second panel unit comprises a single panel having a first surface defining the second exterior surface of the second panel unit and a second surface opposite the first surface thereof and defining the second interior surface of the second panel unit.

29. (canceled)

30. (canceled)

31. A door assembly comprising:
a door defining a first face, a second face opposite the first face, and an opening formed therethrough between the first and second faces,
a glazing unit including a panel unit defining an exterior surface and an interior surface opposite the exterior surface, the panel unit defining a thickness between the interior and exterior surfaces thereof,
a recess defined in the first face of the door about the opening, and
a bonding medium bonded to and between the recess and the interior surface of the panel unit about the recess,
wherein the recess is sized to accommodate the bonding medium and the thickness of the panel unit such that a plane defined by the exterior surface of the panel unit is substantially flush with a plane defined by the first face of the door when the interior surface of the panel unit is bonded to the recess via the bonding medium.

32. A door assembly comprising:
a door defining a first face, a second face opposite the first face, and an opening formed therethrough between the first and second faces,
a glazing unit including a first panel unit defining a first exterior surface and an first interior surface opposite the first exterior surface, a second panel unit defining a second exterior surface and a second interior surface opposite the second exterior surface, and a spacer secured to and between the first and second interior surfaces to define a space between the first and second panel units, the first panel unit sized larger than the second panel unit such that an outer periphery of the first panel unit extends beyond an outer periphery of the second panel unit, and
a recess defined in the first face of the door about the opening, wherein the opening is sized to receive the second panel unit therein with the first panel unit adjacent to its outer periphery received in the recess, and wherein the recess is sized such that a plane defined by the first exterior surface of the first panel unit is substantially flush with a plane defined by the first face of the door when the first interior surface of the first panel unit is secured to the recess.
